(19) United States
(12) Patent Application Publication
(10) Pub. No.: US 2019/0012757 A1
(43) Pub. Date: Jan. 10, 2019

(54) IMAGE PROCESSING APPARATUS AND IMAGE PROCESSING METHOD

(71) Applicant: KYOCERA Document Solutions Inc., Osaka (JP)

(72) Inventor: Akira SHIMADA, Osaka (JP)

(73) Assignee: KYOCERA Document Solutions Inc., Osaka (JP)

(21) Appl. No.: 15/737,121

(22) PCT Filed: May 9, 2017
(86) PCT No.: PCT/JP2017/017572

§ 371 Date: Dec. 15, 2017

(30) Foreign Application Priority Data
Aug. 8, 2016 (JP) 2016-155937

(51) Int. Cl. G06T 1/00; G06F 17/24; G06T 3/00; G06T 5/00; G06T 7/12; H04N 1/387

(52) U.S. Cl. CPC G06T 1/0007; G06F 17/243; H04N 1/387; G06T 5/001; G06T 7/12; G06T 3/00

(57) ABSTRACT

An image processing apparatus includes a line image detection unit and an image clipping unit. The line image detection unit detects a line image of a predetermined type contained in an image to be processed. The image clipping unit clips out a first surrounded region surrounded by the line image. The image clipping unit also clips out, when a line image that does not define the first surrounded region is present, a second surrounded region, surrounded by the line image and an imaginary line drawn between one end and the other of the line image, and generates a second clipped image. The image clipping unit superposes the respective imaginary lines of two second clipped images on each other, to thereby generate a composite image in which the two second clipped images are unified.

### TECHNICAL FIELD

The present invention relates to an image processing apparatus and an image processing method, and in particular to a technique to clip out a partial region of an image to be processed.

### BACKGROUND ART

A technique to clip out a part of an image to be processed, also called a cropping technique, is known. Patent Literature (PTL) 1 cited below discloses a technique to detect a region in a source document surrounded by lines hand-written by a user, and clip out the image in the detected region. In addition, a technique to make a list of the images clipped out as above, according to numerals hand-written by the user. The cited techniques allow the user to designate a portion of the image to be clipped out, through an intuitive and simple operation as writing lines by hand on the source document.

### CITATION LIST

### Patent Literature

[PTL 1] Japanese Unexamined Patent Application Publication No. 2012-151722

### SUMMARY OF INVENTION

### Technical Problem

When the source document is larger than the size of the document table, the region surrounded by the lines hand-written by the user is read in divided sections. In such a case, the technique according to PTL 1 is unable to clip out the image, because the region to be clipped out from the image is unable to be identified. In addition, with the technique according to PTL 1, the user has to write numerals in order to unify the images that have been clipped out into one image, and thus the user has to go through a troublesome operation.

The present invention has been accomplished in view of the foregoing situation, and provides a technique that allows images to be clipped out, and also allows the images that have been clipped out to be unified into one image through a simple operation, despite the source document being larger than the size of a document table, and the region surrounded by marked lines having been read in divided sections.

### Solution to Problem

In an aspect, the present invention provides an image processing apparatus including a detection unit that detects a line image of a predetermined type contained in an image to be processed, and a clipping unit that (i) clips out a first surrounded region surrounded by the line image from the image to be processed, and generates a first clipped image, (ii) clips out, when the line image that does not define the first surrounded region is present, (ii-i) a second surrounded region, surrounded by the line image and an imaginary line drawn between one end and the other of the line image, from the image to be processed, and generates a second clipped image, and (ii-ii) superposes, when two of the second clipped images are present, the respective imaginary lines of the two second clipped images on each other, to thereby generate a composite image in which the two second clipped images are unified.

In another aspect, the present invention provides an image processing method including steps of detecting a line image of a predetermined type contained in an image to be processed, (i) clipping out a first surrounded region surrounded by the line image from the image to be processed, and generating a first clipped image, (ii) clipping out, when the line image that does not define the first surrounded region is present, (ii-i) a second surrounded region, surrounded by the line image and an imaginary line drawn between one end and the other of the line image, from the image to be processed, and generating a second clipped image, and (ii-ii) superposing, when two of the second clipped images are present, the respective imaginary lines of the two second clipped images on each other, thereby generating a composite image in which the two second clipped images are unified.

### Advantageous Effects of Invention

With the foregoing technique, the images can be clipped out, and also the images that have been clipped out can be unified into one image through a simple operation, despite the source document being larger than the size of a document table, and the region surrounded by marked lines having been read in divided sections.

### BRIEF DESCRIPTION OF DRAWINGS

FIG. 1 is a perspective view showing an image forming apparatus, including an image reading apparatus exemplifying the image processing apparatus according to an embodiment of the present invention.

FIG. 2 is a side cross-sectional view showing a configuration of the image reading apparatus.

FIG. 3 is a top view showing an image reading unit of the image reading apparatus.

FIG. 4 is a schematic functional block diagram showing an essential internal configuration of the image reading apparatus.

FIG. 5 is a flowchart showing an operation flow performed by the image reading apparatus.

FIGS. 6A to 6C are schematic drawings each showing an example of an image to be read and an image to be processed.

FIGS. 7A and 7B are schematic drawings each showing an example of the image to be processed.

FIG. 8 is a flowchart showing an operation flow performed by an image reading apparatus according to a variation of the embodiment.

FIG. 9 is a schematic drawing showing an example of the image to be read.

FIG. 10 is a schematic drawing showing an example of the image to be processed.

FIG. 11 is a schematic drawing showing an example of a composite image.

FIGS. 12A to 12C are schematic drawings each showing an example of the image to be read and the image to be processed.

### DESCRIPTION OF EMBODIMENTS

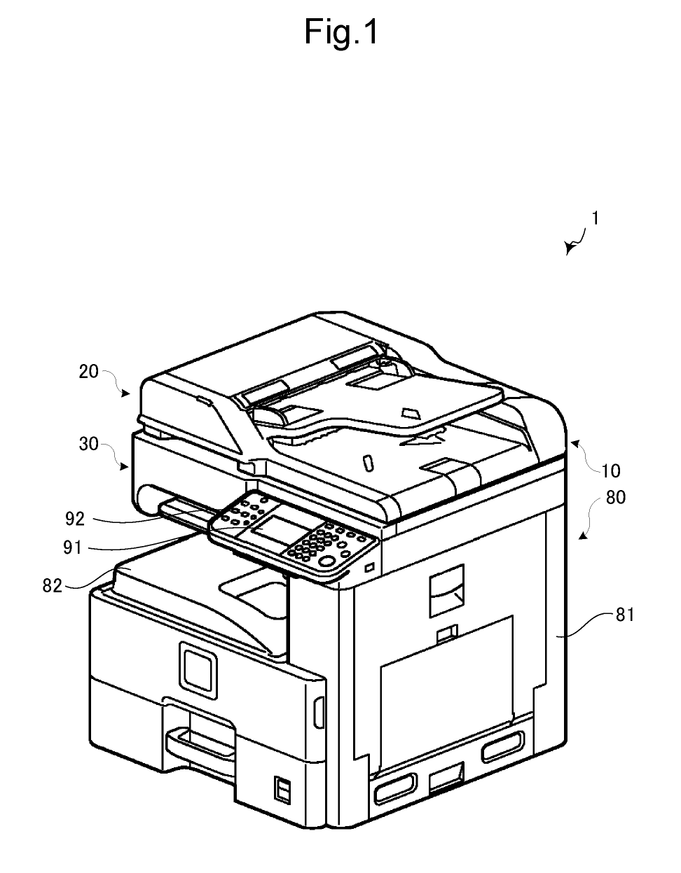

Hereafter, an image processing apparatus and an image processing method according to an embodiment of the present invention will be described, with reference to the drawings. FIG. 1 is a perspective view showing an image forming apparatus, including an image reading apparatus exemplifying the image processing apparatus according to the embodiment of the present invention.

The image forming apparatus 1 is a multifunction peripheral having a plurality of functions, such as facsimile transmission, copying, printing, and scanning. As shown in FIG. 1, the image forming apparatus 1 basically includes a main body 80, and an image reading apparatus 10 provided on an upper side of the main body 2.

In a casing 81, constituting the outer shell of the main body 80, a paper feed unit, an image forming unit, and so forth which are not shown, are accommodated. The image forming unit forms an image on a recording sheet delivered from the paper feed unit, on the basis of image data generated by the image reading apparatus 10. The recording sheet having the image formed thereon undergoes a fixing process, and is discharged to an output tray 82.

An operation unit 91 and a display unit 92 are provided on the front side of the casing 81 of the main body 80. The display unit 92 includes, for example, a liquid crystal display (LCD) or an organic light-emitting diode (OLED) display. The operation unit 91 includes a plurality of operation keys, to be used by a user to input instructions through a screen displayed on the display unit 92.

Instructions such as an image forming instruction and an image reading instruction are inputted to the image forming apparatus 1 or the image reading apparatus 10, by the user through the operation unit 91. The instructions thus inputted are received by a reception unit 106, which will be subsequently described.

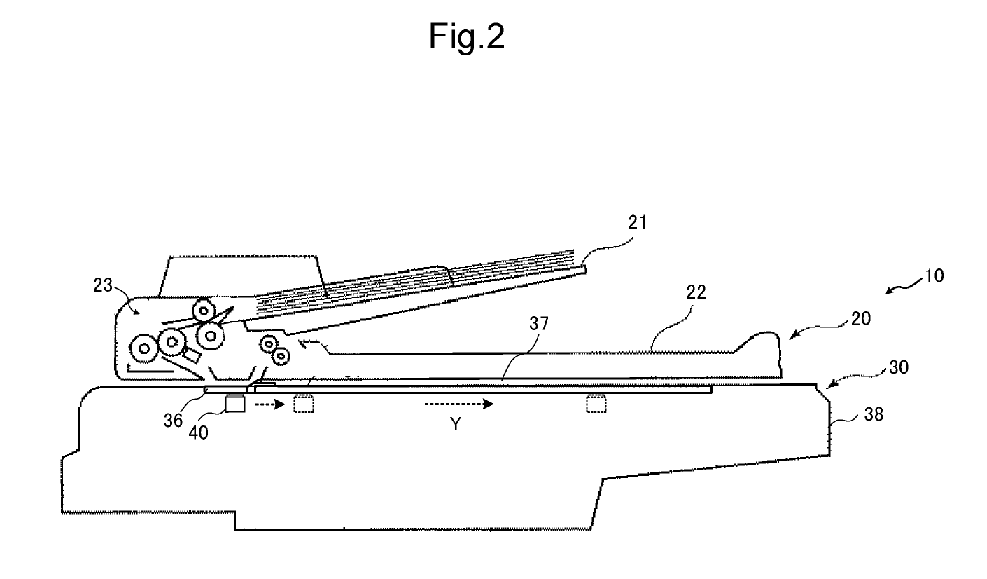

FIG. 2 is a side cross-sectional view showing a configuration of the image reading apparatus 10. The image reading apparatus 10 includes an image reading unit 30, and a document feed unit 20 located on the upper side of the image reading unit 30.

The document feed unit 20 picks up source documents stacked on a document table 21 one by one and transports the source document to a position opposing a document reading slit 36, with a drive mechanism 23 including a paper feed roller and a transport roller, so as to enable the image reading unit 30 to read the source document through the document reading slit 36, and then discharges the source document to a document discharge region 22.

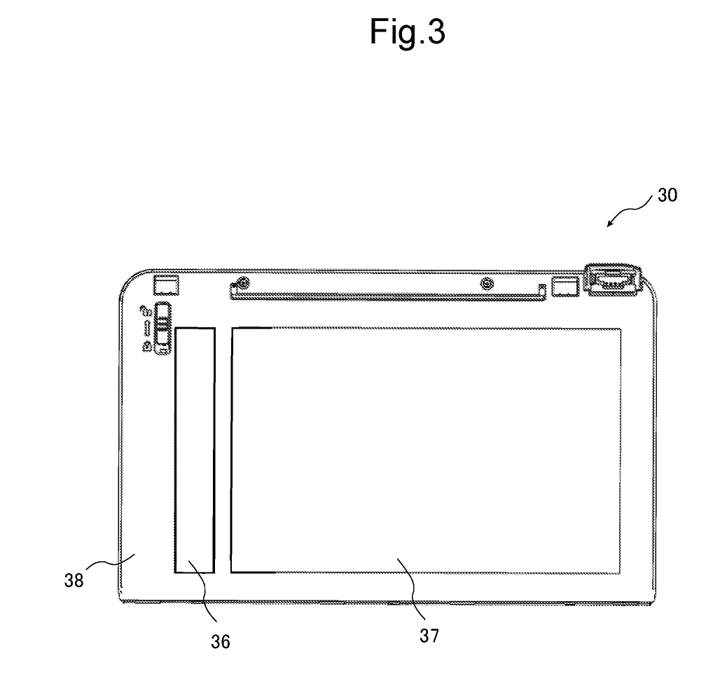

FIG. 3 is a top view showing the image reading unit 30. The image reading unit 30 includes a contact glass 37, fitted in an opening formed in a main body frame 38. A document to be read is placed on the upper surface of the contact glass 37, and thus the contact glass 37 serves as a document table.

Referring again to FIG. 2, a reading unit 40 is provided inside the main body frame 38 and on the lower side of the contact glass 37, so as to move in a sub scanning direction (Y-direction in FIG. 2). The reading unit 40 is made to reciprocate in the sub scanning direction by a non-illustrated reading unit driver including a motor and gears, to read the source document placed on the contact glass 37.

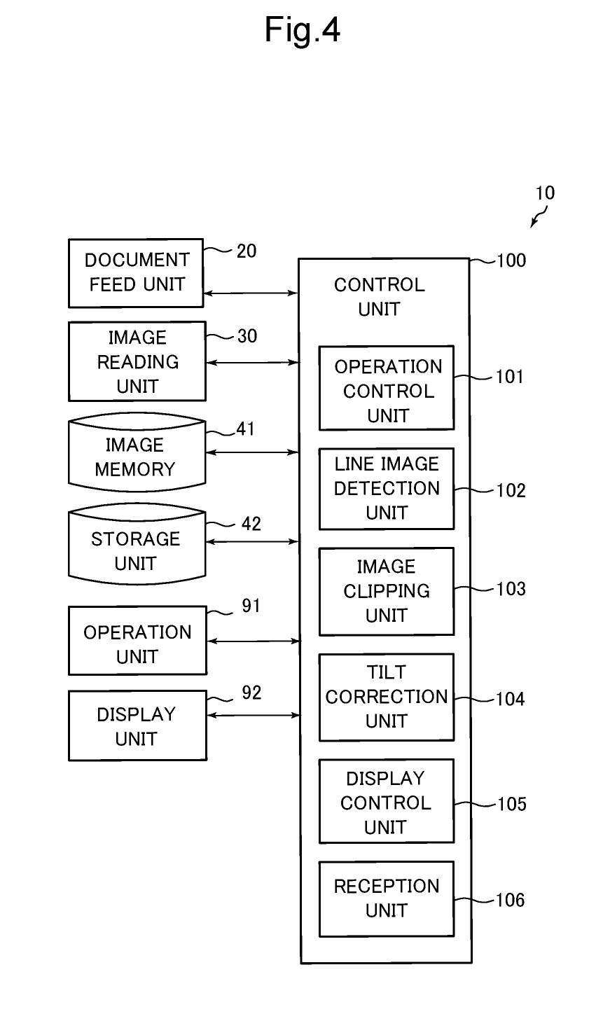

The reading unit 40 stores the image data (image to be processed) representing the source document read as above, in an image memory 41 (see FIG. 4) to be subsequently described, in a lossless compression format such as a raw image format (RAW) or a portable network graphics (PNG).

FIG. 4 is a functional block diagram showing an essential internal configuration of the image reading apparatus 10. The image reading apparatus 10 includes the document feed unit 20, the image reading unit 30, the image memory 41, a storage unit 42, the operation unit 91, the display unit 92, and a control unit 100. The same components as those shown in FIG. 1 are given the same numeral, and the description thereof will not be repeated.

In the image memory 41, an image to be processed generated by the image reading unit 30 from the source document read as above is temporarily stored. The storage unit 42 is a large-capacity storage device such as a hard disk drive (HDD). The storage unit 42 contains programs and data necessary for the image forming apparatus 1 and the image reading apparatus 10 to execute the operation.

The control unit 100 includes a processor such as a central processing unit (CPU) or a digital signal processor (DSP), and memories such as a random-access memory (RAM) and a read-only memory (ROM). The control unit 100 acts as an operation control unit 101, a line image detection unit 102, an image clipping unit 103, a tilt correction unit 104, a display control unit 105, and a reception unit 106, when the processor executes a control program, for example an image processing program, stored in the memories or the storage unit 42. The mentioned components of the control unit 100 may each be realized by a hardware circuit, instead of the operation based on the control program.

The operation control unit 101 controls the overall operation of the image reading apparatus 10 and the image forming apparatus 1. In particular, the operation control unit 101 is configured to control the image reading operation performed by the image reading unit 30, by controlling the operation of the reading unit driver which moves the reading unit 40 in the sub scanning direction.

The line image detection unit 102 is configured to detect a line image of a predetermined type contained in the image to be processed, generated by the image reading unit 30 from the source document read as above. The line image detection unit 102 performs, for example, Hough transform of the image to be processed, to detect an edge position in the image. More specifically, the line image detection unit 102 then detects, as the line image of the predetermined type, a line drawn with a marker of a predetermined color, a line of a predetermined width, and a line of a predetermined form (e.g., a solid line, a broken line, a dot line, and a dash-dot line) contained in the image to be processed, on the basis of the detected edge position. Thus, the line image detection unit 102 easily and properly detects the line image. Here, the line image detection unit 102 exemplifies the detection unit in the present invention.

The image clipping unit 103 is configured to clip out a region surrounded by the line image detected by the line image detection unit 102 (first surrounded region) from the image to be processed, and generate a clipped image (first clipped image). The image clipping unit 103 also clips out, when a line image that does not define the first surrounded region in the image to be processed is detected, a region surrounded by the line image and an imaginary line drawn between one end and the other of the line image (second surrounded region), from the image to be processed, and generates a clipped image (second clipped image). Here, the image clipping unit 103 exemplifies the clipping unit in the present invention.

The tilt correction unit 104 is configured to detect an inclination of the image clipped out by the image clipping unit 103, and rotate the clipped image so as to correct the inclination of the clipped image to a horizontal direction.

The display control unit 105 is configured to control the screen displaying operation of the display unit 92.

The reception unit 106 is configured to receive instructions such as the image reading instruction and the image forming instruction, inputted by the user through the operation unit 91.

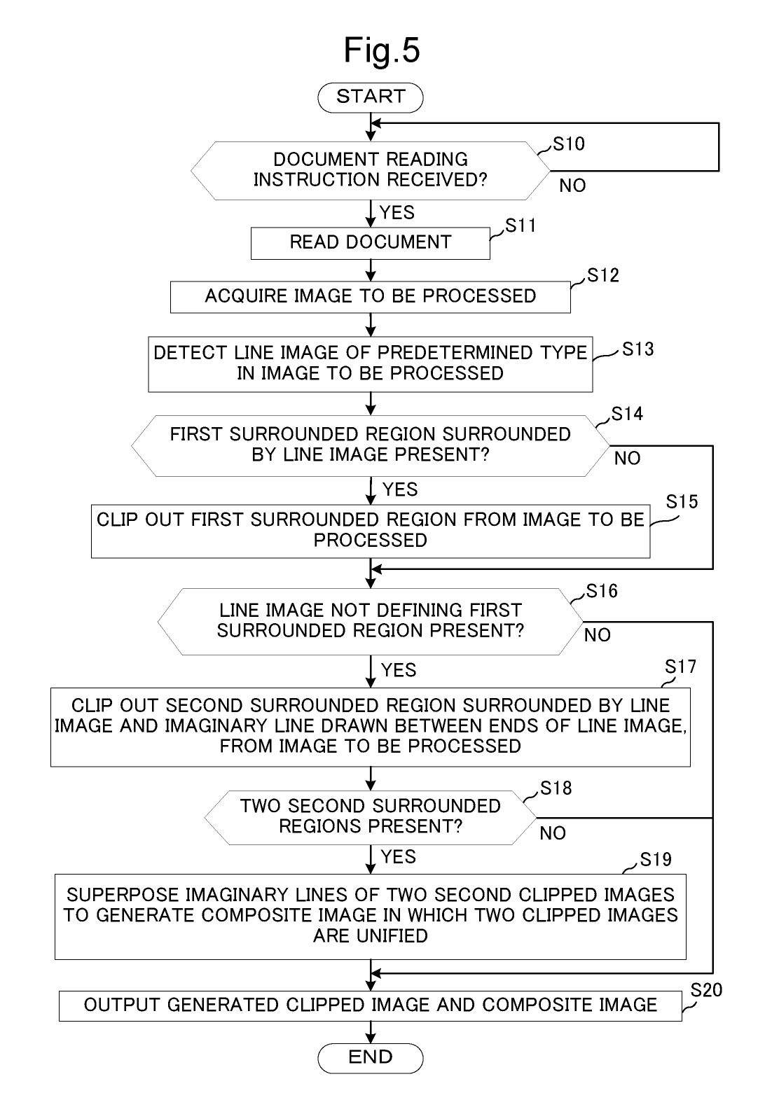

An operation of the image reading apparatus 10 configured as above will be described hereunder. FIG. 5 is a flowchart showing an operation flow performed by the image reading apparatus 10.

When the reception unit 106 receives a reading instruction to read a source document using a cropping function (YES at step S10), the image reading unit 30 reads the source document placed on the contact glass 37 (step S11), and generates the image to be processed (step S12), under the control of the operation control unit 101.

Although the image to be processed is acquired through the reading operation performed by the image reading unit 30 according to the above operation flow, the image to be processed may be acquired by receiving an image from an external information processing apparatus, such as a personal computer (PC).

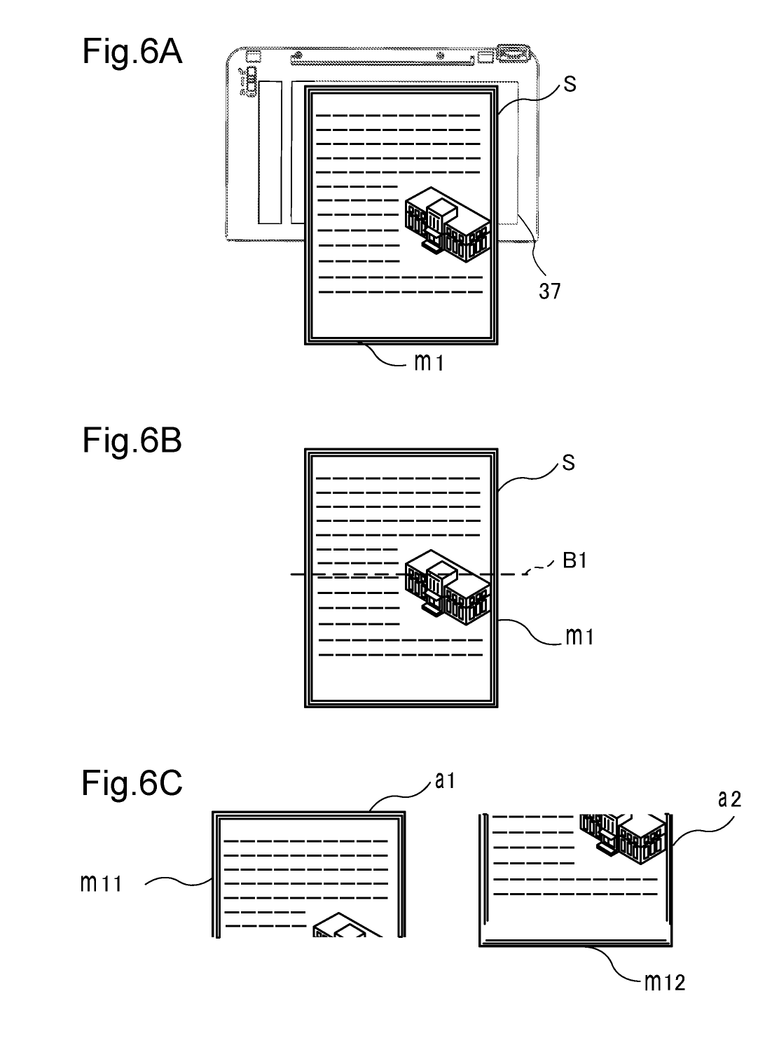

Referring now to FIG. 6A, when an image to be read S is larger than the contact glass 37, the entirety of the source document is unable to be read at a time. In such a case, the source document S is folded or cut along a line B1 as shown in FIG. 6B, and the source document S is read in two reading operations. As result, an image a1 and an image a2 are generated by the image reading unit 30 as images representing the source document S, as shown in FIG. 6C. The image a1 and the image a2 are stored in the image memory 41, as the image to be processed.

In the example shown in FIG. 6B, a marker line m1 is written in the source document S, and a region surrounded by the marker line m1 corresponds to the region that the user wishes to clip out. The marker line m1 is formed into a line image m11 contained in the image a1 and a line image m12 contained in the image a2 as shown in FIG. 6C, as result of reading the source document S in two reading operations.

Referring again to FIG. 5, the line image detection unit 102 detects the line image of the predetermined type, contained in the image to be processed acquired at step S12 (step S13).

The image clipping unit 103 then decides whether the first surrounded region, surrounded by the line image, is present in the image to be processed, and clips out, when the first surrounded region is present (YES at step S14), the first surrounded region from the image to be processed and generates the first clipped image (step S15). The image clipping unit 103 stores the first clipped image generated as above, in the image memory 41.

The image clipping unit 103 also decides whether a line image that does not define the first surrounded region is present in the image to be processed (step S16). When the line image that does not define the first surrounded region is present (YES at step S16), the image clipping unit 103 clips out the second surrounded region surrounded by the line image and the imaginary line drawn between one end and the other of the line image, from the image to be processed, and generates the second clipped image (step S17). In this process, the image clipping unit 103 draws the imaginary line so as to form the second surrounded region in a rectangular shape.

When two of such second surrounded regions are present, in other words when two second clipped images are generated at step S17 (YES at step S18), the image clipping unit 103 superposes the respective imaginary lines of the two clipped images on each other, to thereby generate a composite image in which the two second clipped images are unified (step S19). Then the image clipping unit 103 outputs the first clipped image and the composite image generated through the mentioned process (step S20). More specifically, the outputting operation of the image clipping unit 103 includes, for example, storing the first clipped image and the composite image generated as above in the storage unit 42, causing a communication unit to transmit the first clipped image and the composite image generated as above to an external information processing apparatus, such as a PC, and causing the display unit 92 to display the first clipped image and the composite image generated as above.

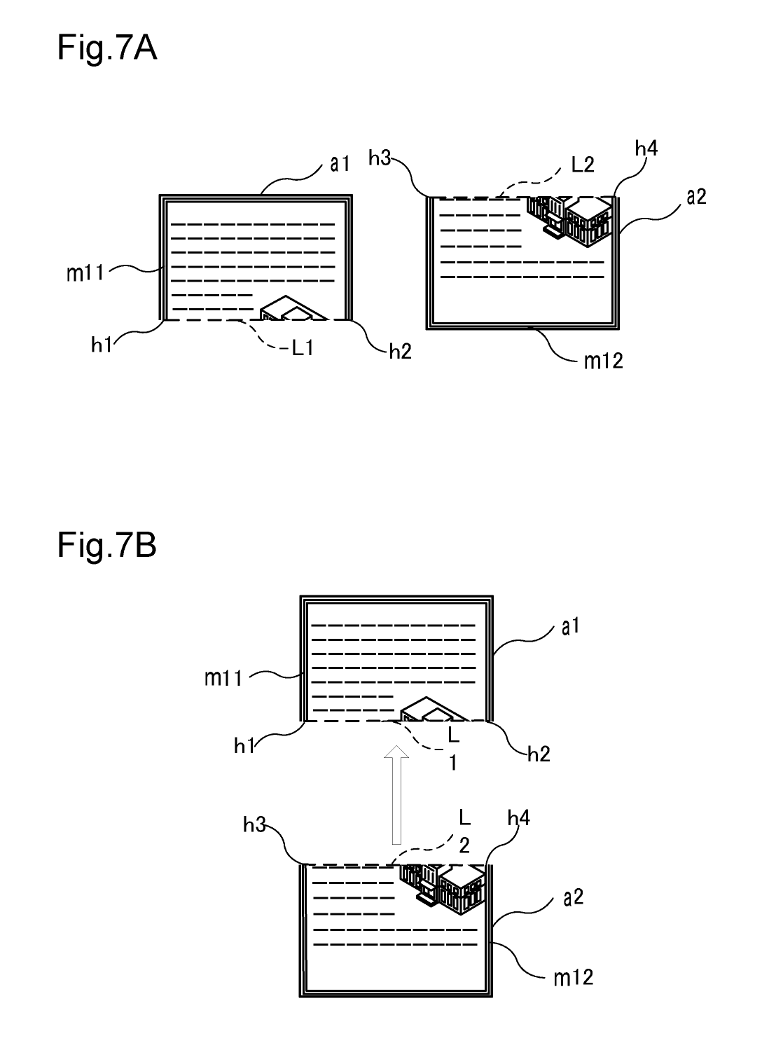

Referring now to FIG. 6C, FIG. 7A, and FIG. 7B, the mentioned operation will be described in further detail. In the image a1 and the image a2 shown in FIG. 6C, which are the image to be processed, the first surrounded region surrounded by the line image m11 or m12 is not present. Accordingly, the image clipping unit 103 draws an imaginary line L1 between terminal points h1 and h2 of the line image m11, as addition to the image a1 as shown in FIG. 7A, and clips out, as the second surrounded region, the region surrounded by the line image m11 and the imaginary line L1. The image clipping unit 103 also draws an imaginary line L2 between terminal points h3 and h4 of the line image m12 as addition to the image a2, and clips out, as the second surrounded region, the region surrounded by the line image m12 and the imaginary line L2. In the examples shown in FIG. 7A, the entirety of the image a1 and the entirety of the image a2 each constitute the second surrounded region, and therefore the image a1 and the image a2 are the clipped images as they are. The image clipping unit 103 then unifies the clipped image a1 and the clipped image a2 by superposing the imaginary line L1 of the clipped image a1 and the imaginary line L2 of the clipped image a2 on each other as shown in FIG. 7B.

As described above, the image reading apparatus 10 configured as above enables the images to be clipped out, and also enables the images that have been clipped out to be unified into one image through a simple operation, despite the source document being larger than the size of the contact glass 37, and the region surrounded by marked lines having been read in divided sections.

Further, for example as shown in FIG. 7A and FIG. 7B, the display control unit 105 may cause the display unit 92 to display the two (second) clipped images a1 and a2, before the composite image is generated as above. Such an arrangement allows the user to confirm in advance the imaginary line L1 of the clipped image a1 and the imaginary line L2 of the clipped image a2, which are to be superposed on each other.

The present invention is not limited to the foregoing embodiment, but may be modified in various manners.

### <Variation 1>

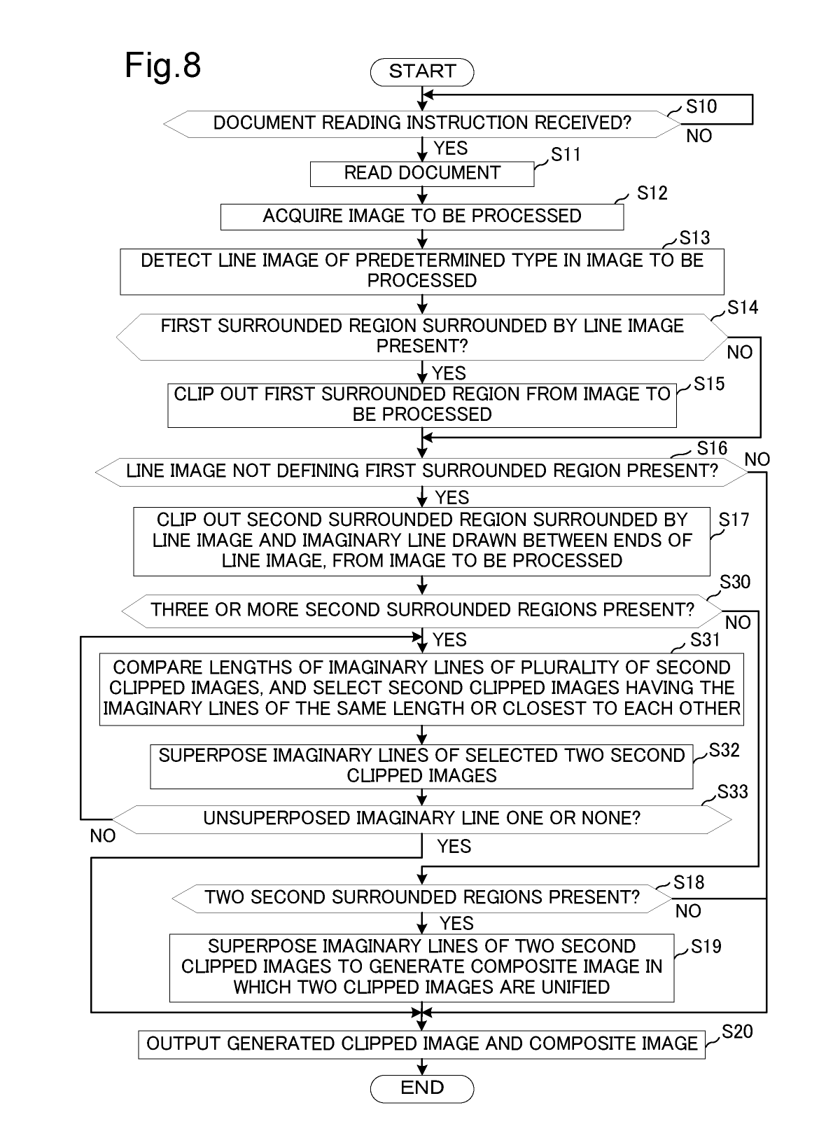

A variation 1 represents the case where three or more of the second clipped images are present. FIG. 8 is a flowchart showing an operation flow performed by the image reading apparatus 10 according to the variation 1. The same steps as those of the flowchart shown in FIG. 5 are given the same numeral, and the description thereof will not be repeated.

When three or more second surrounded regions, in other words three or more second clipped images are present in the image reading apparatus 10 according to the variation 1 (YES at step S30), the image clipping unit 103 compares the lengths of the respective imaginary lines of the plurality of second clipped images, and selects two second clipped images, having the imaginary lines of the same length or closest to each other (step S31). Then the image clipping unit 103 synthesizes the two second clipped images that have been selected, so as to superpose the imaginary lines on each other (step S32). The image clipping unit 103 repeats the operation of step S31 and step S32, until the number of imaginary lines that are not superposed is reduced to one or zero (step S33).

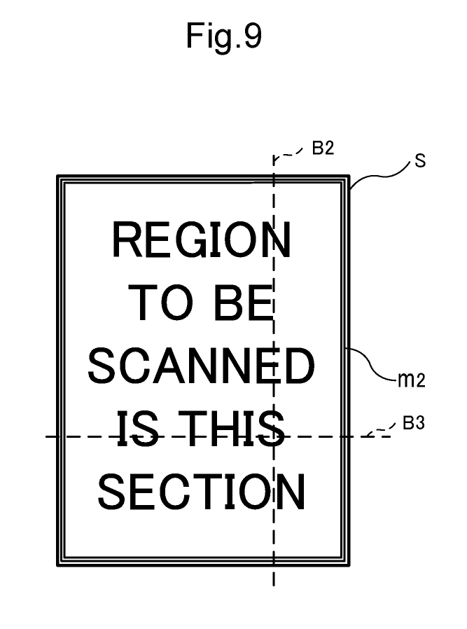

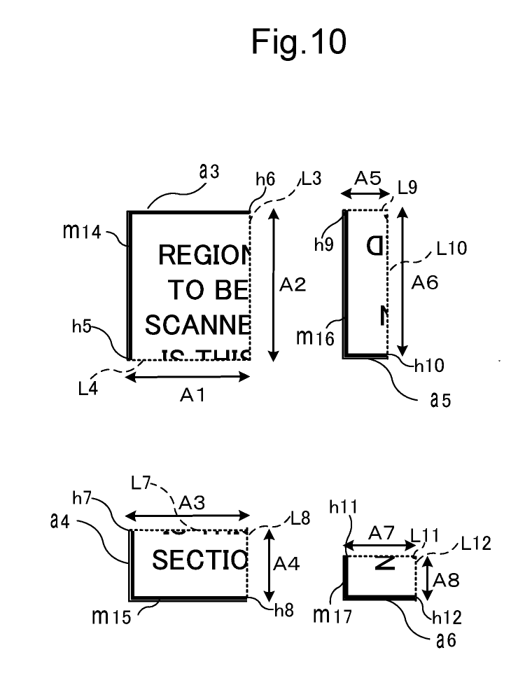

The mentioned operation will be described in further detail, referring to FIG. 9 and FIG. 10. In the example shown in FIG. 9, the image to be read S is folded or cut along a line B2 and a line B3, and is read through four times of reading operations. Accordingly, an image a3, an image a4, an image a5, and an image a6 are generated by the image reading unit 30 as images representing the source document S, as shown in FIG. 10. The image a3, the image a4, the image a5, and the image a6 are stored in the image memory 41, as images to be processed.

In the example shown in FIG. 9, in addition, a marker line m2 is drawn in the source document S, the marker line m2 defining the regions that the user wishes to clip out. The marker line m2 is, as result of the reading of the source document S in four times of reading operations, formed into a line image m14 corresponding to the image a3, a line image m15 corresponding to the image a4, a line image m16 corresponding to the image a5, and a line image m17 corresponding to the image a6, as shown in FIG. 10.

In each of the images a3, a4, a5, and a6, which are the images to be processed, the first surrounded region surrounded by the line image m14, m15, m16, or m17 is not present. Accordingly, the image clipping unit 103 draws imaginary lines L3 and L4 so as to connect the terminal points h5 and h6 of the line image m14, as addition to the image a3 as shown in FIG. 10, and clips out the region surrounded by the line image m14 and the imaginary lines L3 and L4, as the second surrounded region. In this case, the image clipping unit 103 draws the imaginary lines L3 and L4 so as to form the second surrounded region in a rectangular shape. Likewise, the image clipping unit 103 draws imaginary lines L7 and L8 so as to connect the terminal points h7 and h8 of the line image m15, as addition to the image a4, and clips out the region surrounded by the line image m15 and the imaginary lines L7 and L8, as the second surrounded region. Further, the image clipping unit 103 draws imaginary lines L9 and L10 so as to connect the terminal points h9 and h10 of the line image m16, as addition to the image a5, and clips out the region surrounded by the line image m16 and the imaginary lines L9 and L10, as the second surrounded region. Still further, the image clipping unit 103 draws imaginary lines L11 and L12 so as to connect the terminal points h11 and h12 of the line image m17, as addition to the image a6, and clips out the region surrounded by the line image m17 and the imaginary lines L11 and L12, as the second surrounded region.

The image clipping unit 103 compares the lengths A1 to A8 of the respective imaginary lines. For example, the length A1 of the imaginary line L4 is equal to the length A3 of the imaginary line L7, and therefore the image clipping unit 103 synthesizes the image a3 and the image a4, so as to superpose the imaginary line L4 and the imaginary line L7 on each other. In addition, for example the length A5 of the imaginary line L9 is equal to the length A8 of the imaginary line L12, and therefore the image clipping unit 103 synthesizes the image a5 and the image a6, so as to superpose the imaginary line L9 and the imaginary line L12 on each other. All of the imaginary lines drawn in the example shown in FIG. 10 can be superposed on each other by repeating the mentioned operation, and one composite image, in which the images a3 to a6 are unified, can be generated.

Thus, the image reading apparatus 10 according to the variation 1 can generate one composite image, even when three or more second clipped images are present.

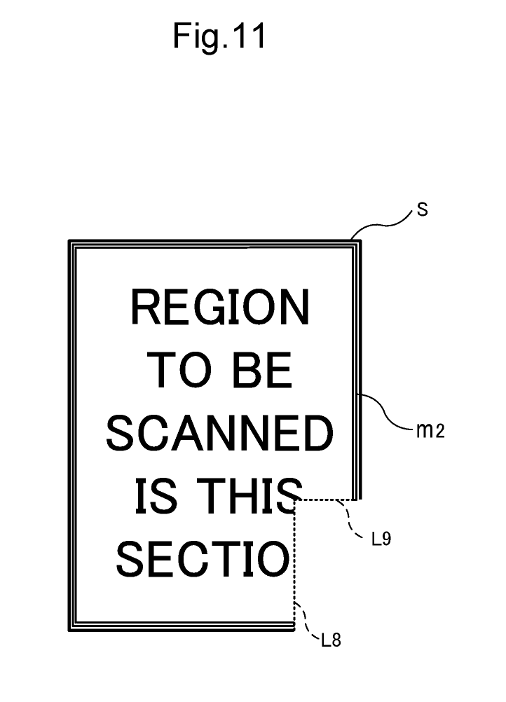

In the case where, as shown in FIG. 11, the imaginary lines L8 and L9 are left over without being superposed, after the composite image is generated as above, the display control unit 105 may cause the display unit 92 to display the composite image, together with an announcement screen for notifying that portions to be unified still remain in the composite image. Such an arrangement allows the user to be aware that a part of the source document has not been read yet.

### <Variation 2>

A variation 2 represents the case where a plurality of clipped regions are present in a single source document.

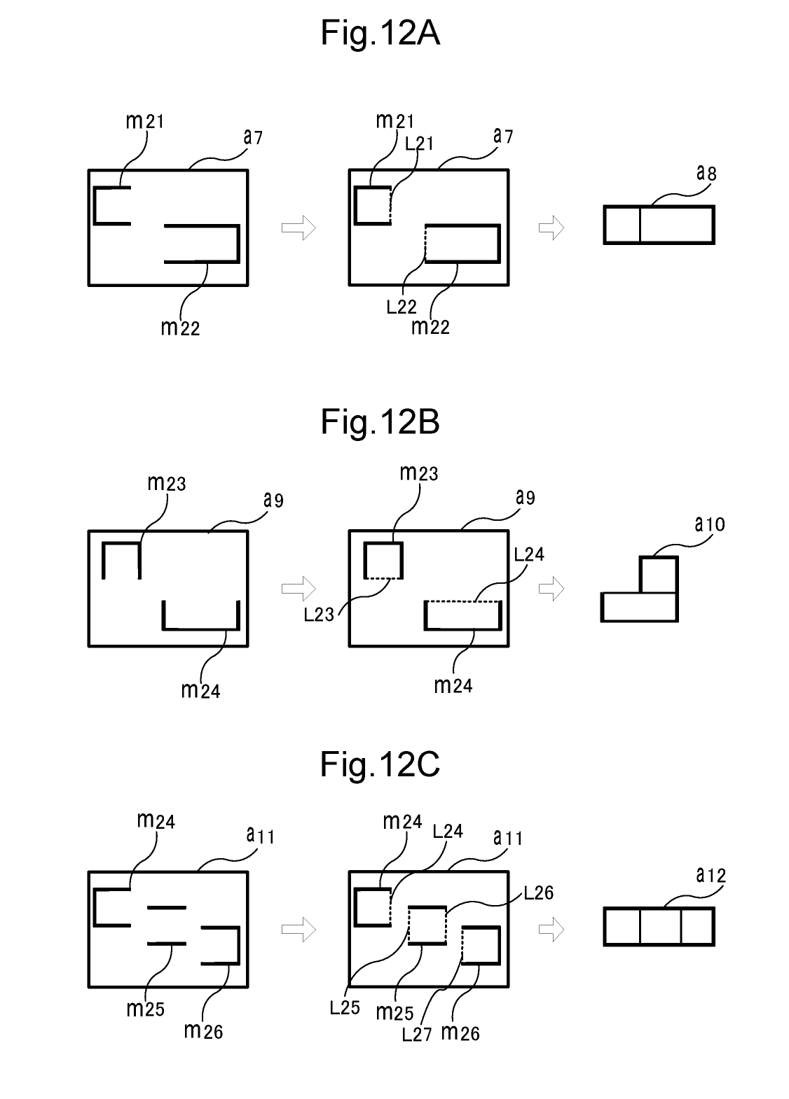

In the example shown in FIG. 12A, an image a7 representing a single source document includes two line images m21 and m22. The image clipping unit 103 draws an imaginary line L21 as addition to the line image m21, and an imaginary line L22 as addition to the line image m22, so as to form the second surrounded regions in a rectangular shape. The image clipping unit 103 then synthesizes the second surrounded region surrounded by the line image m21 and the imaginary line L21, with the second surrounded region surrounded by the line image m21 and the imaginary line L22, so as to superpose the imaginary lines L21 and the L22 on each other, to thereby generate a composite image a8.

In the example shown in FIG. 12B, an image a9 representing a single source document includes two line images m23 and m24. The image clipping unit 103 draws an imaginary line L23 as addition to the line image m23, and an imaginary line L24 as addition to the line image m24, so as to form the second surrounded regions in a rectangular shape. The image clipping unit 103 then synthesizes the second surrounded region surrounded by the line image m23 and the imaginary line L23, with the second surrounded region surrounded by the line image m24 and the imaginary line L24, so as to superpose the imaginary lines L23 and the L24 on each other, to thereby generate a composite image a10.

Here, the imaginary lines L23 and L24 are different in length from each other. Accordingly, the display control unit 105 causes the display unit 92 to display a reception screen for inputting a position where the imaginary lines L23 and L24 are to be superposed on each other. The reception screen includes buttons for selecting, for example, which of the left end, the central position, and the right end of the imaginary line L24 the imaginary line L23 is to be attached to, to synthesize the image. When the reception unit 106 detects a press-down operation of one of the buttons shown in the reception screen, the image clipping unit 103 determines the position where the imaginary lines are to be superposed on each other, according to the press-down operation. In the example shown in FIG. 12B, the image clipping unit 103 determines the position where the imaginary lines L23 and L24 are to be superposed on each other, such that the imaginary line L23 is attached to the right end of the imaginary line L24, according to the press-down operation made on the reception screen and received by the reception unit 106.

In the example shown in FIG. 12C, an image a11 representing a single source document includes three line images m24, m25, and m26. The image clipping unit 103 draws an imaginary line L24 as addition to the line image m24, imaginary lines L25 and L26 as addition to the line image m25, and an imaginary line L27 as addition to the line image m26, so as to form the second surrounded regions in a rectangular shape. The image clipping unit 103 then synthesizes the second surrounded region surrounded by the line image m24 and the imaginary line L24, with the second surrounded region surrounded by the line image m25 and the imaginary lines L25 and L26, so as to superpose the imaginary lines L24 and L25 on each other. Further, the image clipping unit 103 synthesizes the second surrounded region surrounded by the line image m25 and the imaginary lines L25 and L26, with the second surrounded region surrounded by the line image m26 and the imaginary line L27, so as to superpose the imaginary lines L26 and L27 on each other. As result, a composite image a12 is generated.

Here, the imaginary lines L24, L25, L26, and L27 all have the same length. In this case, the image clipping unit 103 selects the images so as to superpose the imaginary lines located closest to each other.

### <Variation 3>

In an image processing apparatus according to a variation 3, the line image detection unit 102 detects a second line image of a predetermined type, which is different from the type of the line image detected in the foregoing embodiment, from the image to be processed. The image clipping unit 103 then clips out a region surrounded by the line image and the second line image from the image to be processed, as the second surrounded region, to thereby generate the second clipped image.

The user writes, by hand, a line of a different type (color or width of the line) from the marker line m1 shown in FIGS. 6A and 6B or the marker line m2 shown in FIG. 9, at the position corresponding to the dot lines L1 and L2 shown in FIG. 7A and FIG. 7B the dot lines L4 to L12 shown in FIG. 10, or dot lines L21 to L27 shown in FIG. 12A to FIG. 12C, together with the marker line m1 or m2. In the image processing apparatus according to the variation 3, the line image detection unit 102 detects the second line image written by the user, instead of identifying the imaginary line drawn between one end and the other of the line image, to thereby identify the second surrounded region and generate the second clipped image.

### <Other Variations>

Although the image processing apparatus is exemplified by the image reading apparatus 10 in the foregoing description, the present invention is also applicable to different apparatuses. For example, the foregoing configuration is applicable to a PC and various other image processing apparatuses.

The control program, such as the image processing program referred to in the foregoing embodiment may be recorded in a computer-readable, non-transitory recording medium such as a hard disk, a CD-ROM, a DVD-ROM, or a semiconductor memory. In this case, computer-readable, non-transitory recording medium having the control program recorded thereon constitutes an embodiment of the present invention.

1. An image processing apparatus comprising:
a detection unit that detects a line image of a predetermined type contained in an image to be processed; and
a clipping unit that (i) clips out a first surrounded region surrounded by the line image from the image to be processed, and generates a first clipped image, (ii) clips out, when the line image that does not define the first surrounded region is present, (ii-i) a second surrounded region, surrounded by the line image and an imaginary line drawn between one end and the other of the line image, from the image to be processed, and generates a second clipped image, and (ii-ii) superposes, when two of the second clipped images are present, the respective imaginary lines of the two second clipped images on each other, to thereby generate a composite image in which the two second clipped images are unified.

2. The image processing apparatus according to claim 1,
wherein, when three or more of the second clipped images are present, the clipping unit selects two second clipped images out of the plurality of second clipped images, and repeatedly superposes the respective imaginary lines of the selected second clipped images on each other, until a number of the imaginary line not superposed yet becomes one or fewer, to thereby generate the composite image.

3. The image processing apparatus according to claim 2,
wherein the clipping unit compares lengths of the respective imaginary lines of the plurality of second clipped images, selects two of the second clipped images having the imaginary lines of the same length or closest to each other, and superposes the imaginary lines of the selected two second clipped images on each other, to thereby generate the composite image.

4. The image processing apparatus according to claim 1, further comprising a reception unit for receiving an instruction from a user,
wherein, when the respective imaginary lines of the selected two second clipped images are different in length, the clipping unit determines a position where the imaginary lines are to be superposed on each other, according to the instruction received by the reception unit, and generates the composite image by superposing the imaginary lines on each other at the determined position.

5. The image processing apparatus according to claim 1,
wherein the detection unit further detects a second line image of a predetermined type different from a type of the line image, from the image to be processed, and
the clipping unit clips out, as the second surrounded region, a region surrounded by the line image and the second line image from the image to be processed, to thereby generate the second clipped image.

6. The image processing apparatus according to claim 1, further comprising:
a display unit; and
a display control unit that causes the display unit to display the two second clipped images, before the clipping unit generates the composite image.

7. The image processing apparatus according to claim 6,
wherein, when the imaginary line that has not been superposed remains after the clipping unit generates the composite image, the display control unit causes the display unit to display, together with the composite image, an announcement screen notifying that the composite image includes a portion to which another image is yet to be added.

8. The image processing apparatus according to claim 1,
wherein the detection unit detects, as the line image of the predetermined type, a line drawn with a marker of a predetermined color, a line of a predetermined width, or a line of a predetermined form, in the image to be processed.

9. An image processing method comprising steps of:
detecting a line image of a predetermined type contained in an image to be processed; and
(i) clipping out a first surrounded region surrounded by the line image from the image to be processed, and generating a first clipped image, (ii) clipping out, when the line image that does not define the first surrounded region is present, (ii-i) a second surrounded region, surrounded by the line image and an imaginary line drawn between one end and the other of the line image, from the image to be processed, and generating a second clipped image, and (ii-ii) superposing, when two of the second clipped images are present, the respective imaginary lines of the two second clipped images on each other, thereby generating a composite image in which the two second clipped images are unified.
